(19) United States
(12) Patent Application Publication
(10) Pub. No.: US 2008/0319831 A1
(43) Pub. Date: Dec. 25, 2008

(54) METHOD AND SYSTEM FOR PROVIDING LOCAL INFORMATION OF PRODUCT

(75) Inventors: Seok Woo CHI, Seongnam (KR); Kyungsun KO, Seoul (KR)

Correspondence Address: EDWARDS ANGELL PALMER & DODGE LLP, P.O. BOX 55874, BOSTON, MA, 02205, US

(73) Assignee: NHN CORPORATION, Seongnam (KR)

(21) Appl. No.: 12/139,962

(22) Filed: Jun. 16, 2008

(30) Foreign Application Priority Data
Jun. 19, 2007 (KR) 10-2007-0059998

(51) Int. Cl. G06F 17/30

(52) U.S. Cl. 705/10

(57) ABSTRACT

A method and system for providing local information of a product is provided. The method includes the steps of: maintaining an original product register database which records an original product register to specify each product; providing a seller with the original product register so that the seller can select information about a product the seller sells or plans to sell, and receiving the selection information; and matching the product selected by the seller with a document provided to the seller.

### CROSS-REFERENCE TO RELATED APPLICATION

This application claims the benefit of Korean Patent Application No. 10-2007-0059998, filed on Jun. 19, 2007, the entire disclosure of which is incorporated herein by reference.

### BACKGROUND

1. Technical Field

The present invention relates to a method and system for providing local information of a product, which stores information of a product sold by an online and/or offline seller in an original product register and provides a document including information about the online and/or offline seller in response to a search query of a user.

2. Background Art

Conventionally, a seller generally advertises a product by creating and distributing an advertisement of the product offline or by creating an online site for the product.

These conventional advertising methods, however, have drawbacks including the following. First, for the seller, advertising costs are significantly high. Second, it is difficult for an online purchaser to obtain information about an offline shop when it sells a product offline. In particular, a search query with respect to a product hardly provides an online user with information about the offline shop. That is, demands of an offline seller are not satisfied since a linked interface between the offline seller and online user based on the product is not established. Third, the compatibility between the information about the products sold online and/or offline in reality and the information about the products registered in an original product register or a product list stored in a search engine is low. Specifically, while the product list or original product register uses expressions known to a person having an ordinary skill in the art, a seller tends to use descriptions different from general expressions used in the art for the same product. That is, since seller's description on the identical product is different from the description registered in the original product register, a description difference on the identical product occurs between the two sides and the compatibility problem occurs. As a result, even when a user enters a search query about a product, it is difficult to search all shops selling the corresponding product due to the description gap between the seller's description on the corresponding product and a description on the corresponding product registered in the original product register, decreasing advertising effect and sales amount.

Accordingly, there is a need for a method and system that can solve the above-described problems associated with prior art.

The above information disclosed in this Background section is only for enhancement of understanding of the background of the invention and therefore it may contain information that does not form the prior art that is already known in this country to a person of ordinary skill in the art.

### BRIEF SUMMARY

The present invention has been made in an effort to solve the above-described problems associated prior art.

In one aspect, the present invention provides a method for providing local information of a product, the method comprising the steps of: maintaining an original product register database which records an original product register to specify each product; providing a seller with the original product register so that the seller can select information about a product the seller sells or plans to sell, and receiving the selection information; and matching the product selected by the seller with a document provided to the seller.

In another aspect, the present invention provides a storage medium encoded with a machine-readable computer program for implementing the method.

In a further aspect, the present invention provides a system for providing local information of a product, the system comprising: an original product register database configured to record an original product register to specify each product; a product selection module configured to provide a seller with the original product register so that the seller can select information about a product the seller sells or plans to sell, and to receive the selection information; and a document matching module configured to match the product selected by the seller with a document provided to the seller.

The above and additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a system for providing local information of a product according to an exemplary embodiment of the present invention;

FIG. 2 is a flowchart illustrating a method of providing local information of a product according to an exemplary embodiment of the present invention;

FIG. 3 is a diagram illustrating operations of providing local information of a product according to an exemplary embodiment of the present invention;

FIG. 4 is a diagram illustrating an original product register recorded in an original product register database according to an exemplary embodiment of the present invention;

FIG. 5 is a diagram illustrating operations of matching a plurality of products selected by a seller with a single document according to an exemplary embodiment of the present invention;

FIG. 6 is a diagram illustrating operations of matching a single product with a document of a plurality of sellers according to an exemplary embodiment of the present invention; and

FIG. 7 is a diagram illustrating a system for providing location information of a product according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

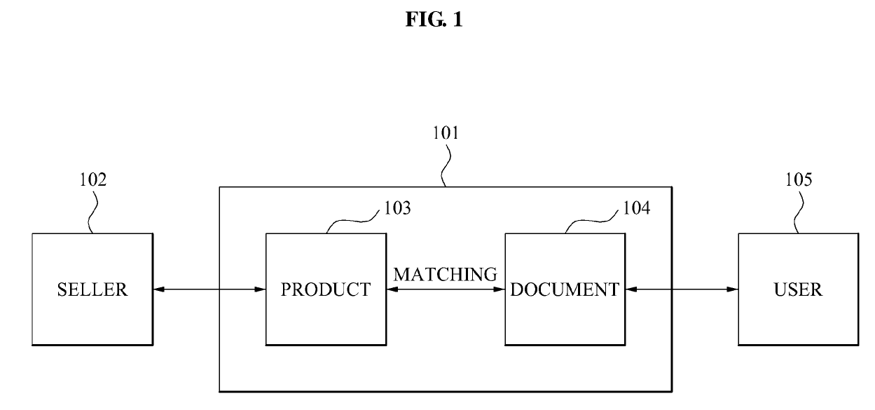

FIG. 1 is a diagram illustrating a configuration of a system for providing local information of a product according to an exemplary embodiment of the present invention.

A product 103 is matched with a document 104, and the document 104 is provided to a user 105, which contains local information about a shop or shops selling the product 103. A seller 102 is provided an original product register from a system 101 for providing local information of a product. In particular, the seller 102 may select the product 103 from among the products included in the original product register. In this instance, the seller 102 may select at least one product it sold, sells or plans to sell. The seller 102 may return information about the selected product 103 to the system 101 for providing location information.

The system 101 for providing location information may match the product 103 with the document 104. The matched document 104 may include shop information about the product 103 sold by the seller 102.

The system 101 for providing location information may receive a search query from the user 105. When the search query is determined to be linked to the product sold by the seller 102, the system 101 for providing location information may repeatedly provide the user with the document 104 having been matched with the product 103.

In this instance, if the seller 102 sells the product 103 via an online site, the seller 102 may simultaneously provide the online site of the seller 102 via forwarding through a uniform resource locator (URL) when providing the document 104 having been matched with the product 103.

If the seller 102 sells the product 103 offline, it may maintain a link between the document 104 and the product 103, thereby providing or advertising the product 103 online without separately creating and managing an additional online site.

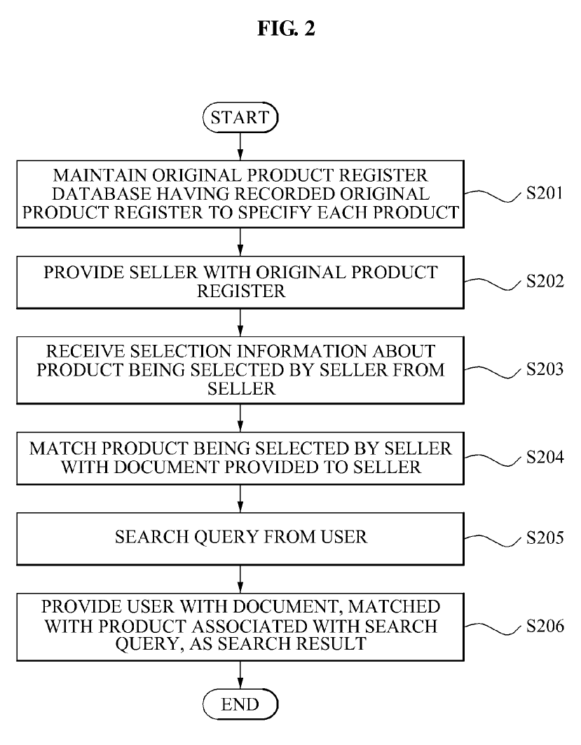

FIG. 2 is a flowchart illustrating a method of providing local information of a product according to an exemplary embodiment of the present invention.

Operation S201 maintains an original product register database having recorded a product original register to specify each product. Specifically, a product identifier may be used to specify a product in the original product register. With respect to each model of a product, the original product register may be recorded in the original product register database.

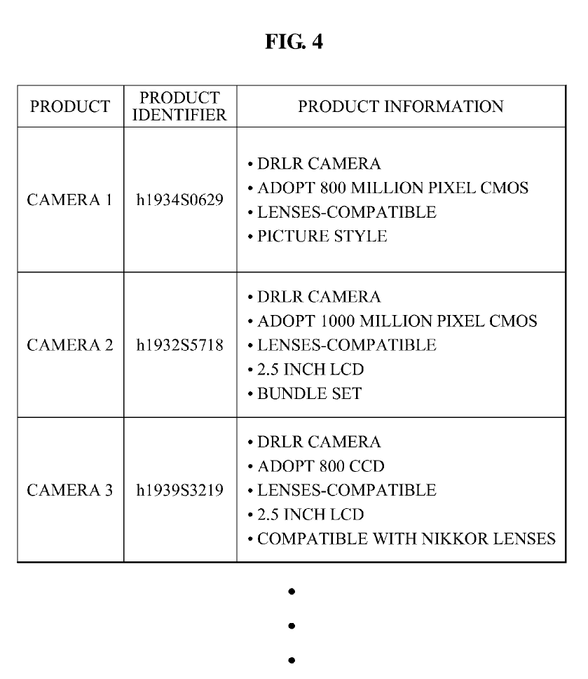

In this instance, although a plurality of products correspond to identical models, when the plurality of products have different features, a different identifier may be established to record each of the plurality of products as a different product in the original product register. The type of the original product register may not be limited thereto, and may be variously established by a system manager. Detailed examples of the original product register will be described later with reference to FIG. 4.

Operation S202 provides the seller with the original product register. The seller can select a product in the original product register.

Preferably, the original product register may be provided to the seller via a user interface. In this instance, the user interface may be embodied in various types to easily search the original product register for the product. Through, for example, a keyword search or a category search, the seller may easily select the product included in the original product register.

Also, the seller may perform the search using a search query suitable for each category. As an example, when the seller sells a product of a digital camera, a search query related to the digital camera is entered and the search is performed via a user interface that is a type of a web page where the search query can be entered.

Also, the seller may easily perform the search for a product using a typical feature of the product to be sold by the seller. As an example, to select a product of a notebook computer, the seller may easily search the notebook computer by entering features of a notebook as the search query, such as a size of a liquid crystal display (LCD), a central processing unit (CPU), and physical dimensions of a notebook computer.

Operation S203 receives the information about the product selected by the seller in the original product register. The selection information about the product may include a product name or a product identifier being selected by the seller. The number of the selected product may be at least one. Also, an identical product may be selected by a plurality of different sellers.

Preferably, the selection information about the product may be provided to the seller via a robot or an algorithm according to a prescribed selection criterion set in a system for providing location information of a product. In this instance, the matching operation may be more quickly performed since a product is automatically selected in the original product register internally. However, it is possible that a product sold by the seller and an automatically selected product are not accurately matched together. To facilitate accurate matching, the seller may be given an opportunity to amend the selection information automatically provided.

Operation S204 matches the product selected by the seller with a document provided to the seller. The document may include shop information of the product selected by the seller.

In this instance, the document may correspond to a general page provided on the Internet, and more particularly, to a page exposed via a user's search on an Internet shopping intermediary site. However, the document may not be limited to the above, and may be embodied in other domains and types.

By including shop information in the document, the seller may increase reliability on a product description when a seller sells products offline. When a seller sells products both online and offline, the document may include a URL of the online site of the seller. When a user later performs a search via a search query, the search result may forward the user via a URL to a corresponding online site selling the product, in addition to providing the document having been matched with the product as a search result.

Through this, the seller may provide a user with an advertisement about a product and provide a shopping service more aggressively. Consequently, operation S204 is to link a product to be sold by a seller with a document including shop information of the product. Also, the seller may manage the product to be compatible and to be standardized via the document.

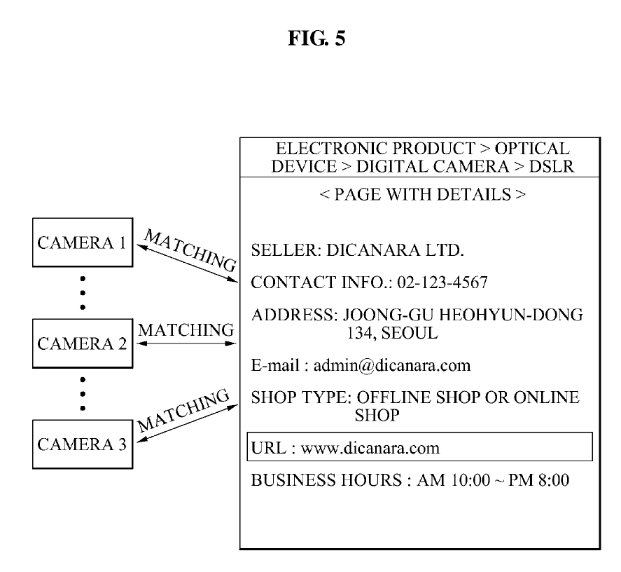

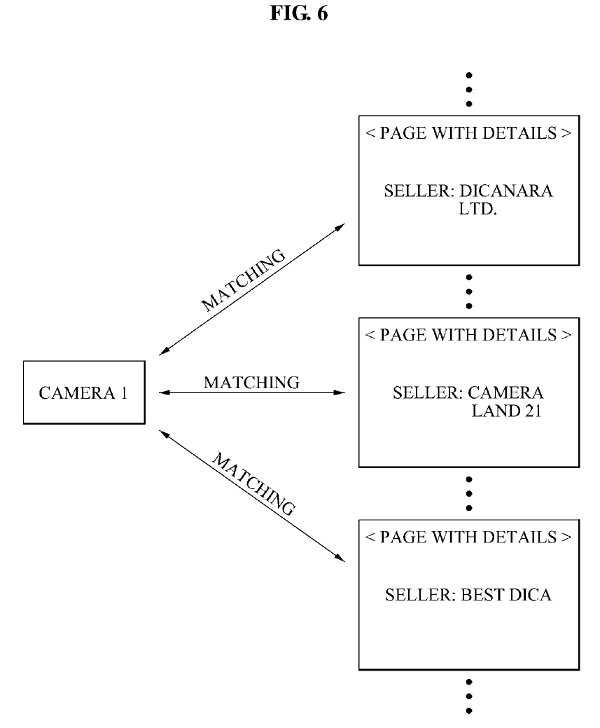

Matching a product with a document may be performed in various ways. For example, at least one product and a single document can be matched. That is, at least one product is sold by a seller. Also, a single product can be matched with at least one document. That is, there is at least one seller with respect to an identical product. In addition, at least one product can be matched with at least one document. Consequently, by varying matching methods, more local information of a product and an accurate search result can be provided to a user. The matching methods will be described later with reference to FIGS. 5 and 6.

In operation S203, it is described that the system for providing location information of the product automatically selects the product via the robot or algorithm, and the seller appropriately amends the automatically selected product according to conditions. In this instance the product which is amended by the seller may be matched with the document.

Operation S205 receives a search query from a user. Desirably, the search query may be a query about a product that the user wants to purchase or to search. Namely, the search query may include a query associated with the product, such as a product name, a business type, a product company, a product feature, a product price, a product shop, or a combination of the above. As an example, a product name may be received as the search query, or a query about a specific product in a specific local area in a type of a combination of a product name and a product selling area may be received.

Operation S206 provides the user with a document as the search result, which have been matched with the product associated with the search query. In particular, the document having been matched with the product through operation S204 is provided to the user. The document being provided as the search result may be changed according to a service, a product, or contents of an advertisement.

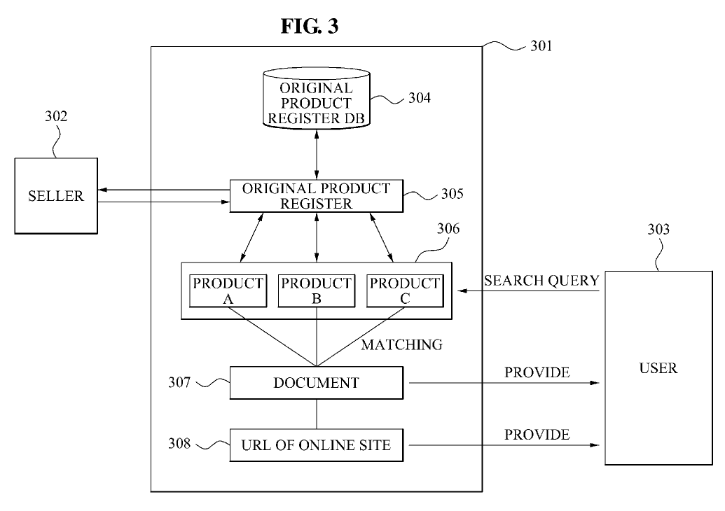

FIG. 3 is a diagram illustrating operations of providing local information of a product according to an exemplary embodiment of the present invention.

As illustrated in FIG. 3, a system 301 for providing location information of a product may provide a seller 302 with an original product register recorded in an original product register database 304. The seller 302 may select a product in the original product register 305. The system 301 for providing local information may receive selection information about the product provided to the seller 302.

Specifically, the system 301 for providing local information may provide the seller 302 the selection information about the product via a robot or an algorithm according to a prescribed selection criterion, and the selection information may be amended by the seller 302. The system 301 for providing local information may receive the amended selection information from the seller 302.

The product selected by the seller 302 in the original product register 305 or included in the amended selection information may be matched with a document 307 provided to the seller 302. As illustrated in FIG. 3, for example, products A, B, and C selected by the seller 302 in the original product register 305 are referred to as seller's products 306. In this instance, the seller's products 306 may be actual products selected by the seller 302 and actually sold by the seller 302.

In FIG. 3, it is illustrated that each of the products A, B, and C included in the seller's products 306 is matched with a single document 307. The above described matching method is only an example, and various matching methods will be described in detail with reference to FIGS. 5 and 6.

The document 307 may include shop information of a product sold by the seller 302, that is local information of the product. In this instance, the local information of the product may be associated with the shop selling the product, and may correspond to a shop name selling the product, contact information of the shop, an address of the shop, an e-mail address of the shop, business hours of the shop, and the like. The local information, however, is not limited to the above mentioned examples, and may include other information associated with the shop.

The system 301 for providing location information may receive a search query from a user 303. Also, the document 307 matched with the seller's products 306 associated with the search query may be provided to the user 303 as a search result. Generally, the document 307 may include shop information of the seller's products 306.

When the seller 302 sells the seller's products 306 via an online site, a URL 308 of the online site may be included in the document 307 as one type of the shop information. In this instance, the system 301 for providing location information may provide the user 303 with the document 307 and the URL 308 of the online site as the search result.

It is possible that description on the seller's products 306 is different from that in the original product register 305. It is also possible that different sellers use different descriptions on a particular product. According to a preferred embodiment of the present invention, a mutual linkage tool may make them compatible with each other. As an example, when the seller 302 sells a camera under the name of ‘Canon Thirty D’ and the original product register 305 describes the name of the camera as ‘Canon 30D,’ the mutual linkage tool may make them compatible with each other. That is, a document matching the description ‘Canon 30D’ in the original product register 305 may be provided even when the seller uses a different description. With this function, highly reliable search result may be provided.

FIG. 4 is a diagram illustrating an original product register recorded in a product original register database according to an exemplary embodiment of the present invention.

The original product register is to specify each product, and may be recorded in the original product register database for each product. An original product register is established for each product, and the original product register may be identified via a product identifier. The product identifier may have a unique value for each product.

Referring to FIG. 4, cameras 1, 2 and 3 may be different models. Alternatively, the cameras may be same models but they may have different specifications. Trade names of products may also be used to identify/specify products.

The original product register is read from the original product register database and may be provided to the seller. The seller may select a product by referring to the product name and product information in the original product register.

The number of products selected by the seller in the original product register may be at least one. It is not necessary that the selected products are identical types. Reference elements to select the product by the seller may not be limited to examples shown in FIG. 4, and may include other elements.

The original product register may include a number of products since it may generally include products and detailed models of the products. A user interface may be given to the seller so that the seller may easily search a product to select by entering a keyword via the user interface. The seller may enter a product name via the user interface or enter a product identifier that the seller is already aware of. Otherwise, the seller may search the product to select by entering a typical feature of a corresponding product. The search methods are not limited to the above described, and the seller may perform the search through various elements to select a product.

The seller may provide the system for providing local information with the information selected in the original product register. The selection information may be generally a list of a product selected by the seller, and may include a product identifier. Consequently, when the seller selects the product in the original product register, the system for providing location information may provide the user with a result by matching the selected product with the document provided to each seller.

FIG. 5 is a diagram illustrating operations of matching a plurality of products selected by a seller with a single document according to an exemplary embodiment of the present invention.

It is assumed that a seller sells cameras 1, 2 and 3 and has selected them in the original product register. Each of the cameras may be matched with a document provided to the seller. That is, as one of the matching methods as described in FIG. 2, at least one product is matched with a single document.

An example of the document matched with the selected products is shown in FIG. 5. In this instance, the document may contain local information about cameras including information about shops selling the cameras. As illustrated in FIG. 5, the document may include detailed categories with respect to a corresponding product. Specifically, when the cameras are digital single lens reflex (DSLR) cameras, a category including the document is “DSLR,” and categories may be established in an order of “electronic products>optical devices>digital cameras>DSLR.”

Also as illustrated in FIG. 5, in the case of an Internet shopping intermediary site, the document may be represented as a page with details. In this instance, the page with details may include, but not limited to, e.g., the name of a shop selling the product, contact information of the shop, an address of the shop, an e-mail address of the shop, a shop type, a URL of an online site of the shop, and business hours of the shop.

In this instance, when the seller sells products both online and offline, a URL of the online site corresponding to an online shop may be included in the document as well as the offline shop information. When a search query being entered from a user is associated with any one of the cameras, the document shown in FIG. 5 may be provided as a search result. Also, the online site corresponding to the document forwarding the user to the online site via a URL may be provided to the user.

As described above, an offline seller may easily start to advertise a product online. Also, a seller selling a product both online and offline may variously provide a user with shop information, and effectively entice the user to the shop. Consequently, an online/offline integrated interface of a product may be established.

FIG. 6 is a diagram illustrating operations of matching a single product with a document of a plurality of sellers according to an exemplary embodiment of the present invention.

It is illustrated that a product being selected by a seller is camera 1. The number of sellers may be at least one. A document provided to each seller may be matched with the camera 1 since a plurality of sellers sell an identical product. Specifically, from the matching methods described with reference to FIG. 2, a single product is a matched with at least one document.

As shown in FIG. 6, sellers including ‘dicanara’, ‘camera land 21’, and ‘best dica’ sell a camera 1, and a document provided to each of the sellers is matched with the camera 1 which is selected by each seller. The camera 1 may be matched with a document provided to each seller, which includes shop information.

Through the above described operation, a user searching for a specific product may have various selections for the specific product by being proved with information of a plurality of shops. Also, an error occurring during the course of selecting a product may be decreased and shops may be easily compared with each other since more shop information may be provided with respect to a search result of the user.

According to a preferred embodiment, it is possible to combine the matching method described with reference to FIG. 5 and the matching method described with reference to FIG. 6.

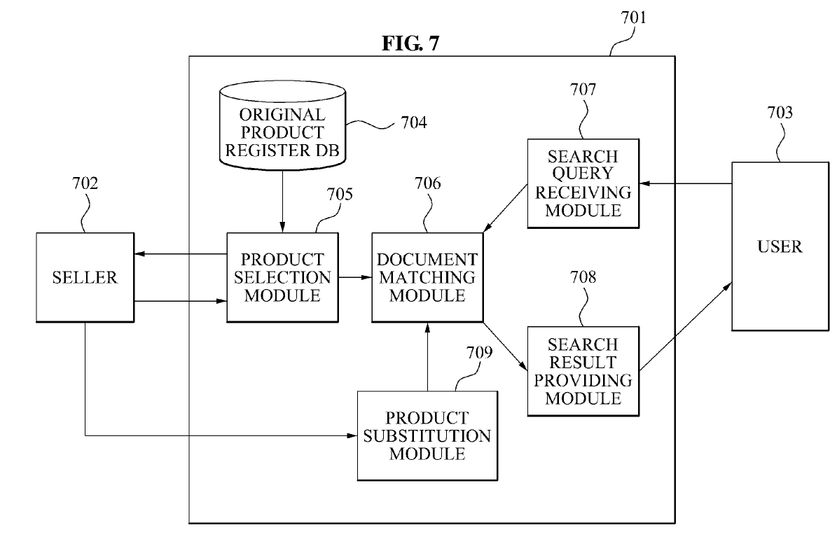

FIG. 7 is a diagram illustrating a system 701 for providing location information of a product according to an exemplary embodiment of the present invention.

The system 701 for providing location information may include an original product register 704, a product selection module 705, a document matching module 706, a search query receiving module 707, a search result providing module 708, and a product linking module 709.

The original product register database 704 may maintain an original product register to specify each product. Specifically, the original product register is established for each product, and may be identified via a product identifier. The product identifier may have a unique value for each product.

The product selection module 705 may provide the seller 702 with the original product register, and receive information about the product selected by the seller 702. That is, the original product register recorded and maintained in the original product register 704 may be read to be provided to the seller 702. The seller 702 may select a product in the original product register by referring to a product name and product information recorded in the original product register. The number of product being selected by the seller 702 may be at least one, and the selected products need not be an identical type.

It may be difficult for the seller 702 to select a product since a great number of products may be included in the original product register. Therefore, the product selection module 705 provides the seller 702 with the original product register via a user interface, with which the seller 702 performs a keyword search.

The product selection module 705 may receive from the seller 702 the information about the product being selected by the seller 702. The selection information may be a list of products selected by the seller 702, or may include a product identifier.

As an example, the product selection module 705 may provide the seller 702 with information selected according to a prescribed selection criterion. In this instance, while the selection operation may be quickly processed since a product is automatically selected internally, accuracy of the selection may be deteriorated. The accuracy can be maintained or enhanced by providing the seller 702 with an opportunity to amend the automatically selected product appropriately.

The document matching module 706 may match the product selected by the seller 702 with a document provided to the seller 702. In this instance, the document may include shop information selling the selected product. The shop information of the product may include a URL of an online site of the product when the selected product is sold in the online site.

For example, the product selection module 705 may provide the seller 702 with the information selected according to a prescribed selection criterion, and may receive the selection information which has been amended by the seller 702. In this instance, the document matching module 706 may match a product corresponding to the selection information amended by the seller 702 with the document.

The document matching module 706 matches the information with the document in various ways. For example, at least one product selected by the seller 702 is matched with a document in case where the seller 702 sells a plurality of products via a single shop. Also, an identical product selected by at least one seller 702 is matched with a document provided to each of the at least one seller 702 in case where a plurality of sellers 702 sell a single product. In addition, the above two methods may be combined. The combined method is suitable to be applied a complex product selling structure.

The search query receiving module 707 may receive a search query from the user 703. It is desirable that the search query is about a product the user 703 wants to purchase or search. That is, the search query may include a query associated with a product, such as a product name, a business type, a company name, a product feature, a product price, a product shop, or a combination of the above.

The search result providing module 708 may provide the user 703 with a document matched with a product associated with the search query. That is, the user 703 is provided local information included in the document matched with the product to purchase or search.

With that linked interface between the user 703 and the seller 702, the user 703 can easily and effectively search a product and the seller 702 can effectively advertise the product it sells online and/or offline.

As described above, when the seller 702 sells the product in an online site, a document forwarding the user 703 to the online site via a URL may be provided to the user 703 as a search result.

It is possible that description on the product the seller sells online and/or offline is different from that in the original product register. It is also possible that different sellers use different descriptions on a particular product. According to a preferred embodiment of the present invention, the product linkage module 709 may make them compatible with each other. In case of a product sold in an online site, for example, the product linkage module 709 may link the product to a product included in the original product register. The document matching module 706 may match the product sold in the online site and a product linked by the product linkage module 709, from among the products included in the original product register, with a document, thereby increasing the reliability of the search result.

The method for providing location information of a product according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As discussed above, the present invention provide various advantages including the following. For example, it is possible to allow an offline seller to easily start to advertise a product online by matching the product sold by the offline seller with a document provided to a user. It is also possible to provide a user with various information about a shop selling a product online and/or offline and to effectively entice the user to the shop. Further, it is possible to provide a user with more amount of local information, and to provide an accurate search result by varying matching methods of a product with a document. In addition, it is possible to increase reliability on a product description by including shop information of the product in a document provided to a user, and to manage the product to be standardized and compatible. Additionally, it is possible to provide a search result that can directly forward a user to an online site via a URL when a seller sells a product online and/or offline.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A method for providing local information of a product, the method comprising the steps of:
maintaining an original product register database which records an original product register to specify each product;
providing a seller with the original product register so that the seller can select information about a product the seller sells or plans to sell, and receiving the selection information; and
matching the product selected by the seller with a document provided to the seller.

2. The method of claim 1, wherein the step of providing and receiving comprises providing the seller with information about the product being selected according to a prescribed selection criterion and receiving the selection information after the seller is given an opportunity to amend the selection information, and wherein the step of matching comprises matching the product corresponding to the selection information amended by the seller with the document.

3. The method of claim 1, wherein the document comprises information about shop selling the product selected by the seller.

4. The method of claim 3, wherein the shop information comprises at least one of category of the product, name of the shop, contact information of the shop, mailing address of the shop, e-mail address of the shop, business hours of the shop, and uniform resource locator (URL) of online site of the shop.

5. The method of claim 4, further comprising the step of linking products sold in the online site with products included in the original product register, wherein the step of matching includes matching the products linked to the products sold in the online site, from among the products included in the original product register, with the document.

6. The method of claim 1, wherein when at least one product is selected by the seller, the step of matching includes matching the selected product or each of the selected products with the document.

7. The method of claim 1, wherein when a product is selected by at least one seller, the step of matching includes matching the selected product with each document provided to the seller or each of the sellers.

8. The method of claim 1, further comprising the steps of:
receiving a search query from a user; and
providing the user with a document as a search result, which is matched with a product associated with the search query.

9. The method of claim 8, wherein when the seller sells the product associated with the search query in on online site, the step of providing the user with the document includes providing the user with a document as a search result, which forwards the user to the online site via the URL.

10. A storage medium encoded with a machine-readable computer program for implementing a method for providing location information of a product, the method comprising the steps of:
maintaining an original product register database which records and maintains an original product register to specify each product;
providing a seller with the original product register so that the seller can select information about a product the seller sells or plans to sell, and receiving the selection information; and
matching the product selected by the seller with a document provided to the seller.

11. A system for providing local information of a product, the system comprising:
an original product register database configured to record an original product register to specify each product;
a product selection module configured to provide a seller with the original product register so that the seller can select information about a product the seller sells or plans to sell, and to receive the selection information; and
a document matching module configured to match the product selected by the seller with a document provided to the seller.

12. The system of claim 11, wherein the product selection module provides the seller with the information about the product selected according to a prescribed selection criterion and receives the selection information after the seller is given an opportunity to amend the selection information, and the document matching module matches the product corresponding to the selection information amended by the seller with the document.

13. The system of claim 11, wherein the document comprises information about shop selling the product selected by the seller.

14. The system of claim 13, wherein the shop information comprises at least one of category of the product, name of the shop, contact information of the shop, mailing address of the shop, e-mail address of the shop, business hours of the shop, and URL of an online site of the shop.

15. The system of claim 14, further comprising a product link module configured to link products sold in the online site with products included in the original product register, wherein the document matching module matches the products linked to the products sold in the online site, from among the products included in the original product register, with the document.

16. The system of claim 11, wherein when at least one product is selected by the seller, the document matching module matches the selected product or each of the selected products with the document.

17. The system of claim 11, wherein when a product selected by at least one seller, the document matching module matches the selected product with each document provided to the seller or each of the sellers.

18. The system of claim 11, further comprising:
a search query receiving module configured to receive a search query from a user; and
a search result providing module configured to provide the user with a document as a search result, which is matched with a product associated with the search query.

19. The system of claim 18, wherein when the seller sells the product associated with the search query in an online site, the search result providing module provides the user with a document as a search result, which forwards the user to the online site via the URL.
